(19) United States
(12) Patent Application Publication
(10) Pub. No.: US 2004/0051503 A1
(43) Pub. Date: Mar. 18, 2004

(54) Multi-function car accessory

(76) Inventor: Eagle Fan, Chupei City (TW)

Correspondence Address: SUPREME PATENT SERVICES, POST OFFICE BOX 2339, SARATOGA, CA, 95070, US

(21) Appl. No.: 10/243,548

(22) Filed: Sep. 14, 2002

(51) Int. Cl. H02J 7/00

(52) U.S. Cl. 320/117; 307/10.1

(57) ABSTRACT

A car accessory includes an elongate bar removably received and retained in a retainer that is selectively attached to a sun visor of a car. The elongate bar forms a connector for connection with a mobile phone and an electrical system of the car. A speaker is mounted to the bar for broadcasting audio signal from the mobile phone and giving off sound signals. A control circuit is arranged in the bar for controlling the operation of the car accessory and synthesizing the sound signals. A battery set is mounted in the bar for powering the car accessory. Three lighting units are mounted to the bar and controlled by switches to selectively give off light signals and serve as a flashlight. The lighting units are operable with the speaker to give off visual and sound signals.

### FIELD OF THE INVENTION

The present invention relates generally to a car accessory, and in particular to a multi-function car accessory that combines a sound generator, a light generator and a hand-free mobile phone holder together and may also serve as a signal bar and a flashlight.

### BACKGROUND OF THE INVENTION

Hand-free mobile phone holders are often installed in a car to allow a driver to answer a phone call without hand holding the mobile phone whereby traffic accidents resulting from absent-mindedness are avoided. The hand-free mobile phone holder usually comprises a speaker and/or an earphone jack for connection with the mobile phone so that the driver does not need to hand hold the mobile phone close to his or her ear for listening. No other function is provided by the conventional hand-free mobile phone holder.

Automobile breakdown is often encountered by car drivers. A warning sign is commonly placed at a distance from the broken car to give a warning to the drivers of the following cars. Lighting device is also needed in an automobile breakdown, especially in dark environments, for the driver to fix the automobile. In addition, the lighting device also helps warning the drivers of following cars. Often, people put one or two flashlights in the back trunk of their cars. The flashlight may just get out of order if it is not properly maintained. Thus, it is desired to have a car accessory that combines a warning device capable of giving sound and light warnings and a hand-free phone holder and also serves as a lighting tool in dark environments.

### SUMMARY OF THE INVENTION

An object of the present invention is to provide a car accessory providing the functions of a hand-free mobile phone holder, a lighting device, a warning generator and a signal bar which allows a driver to take a phone call without hand holding the phone and also serves as a warning device in an automobile breakdown, especially in dark environments for enhanced safety in both driving condition and breakdown condition.

Another object of the present invention is to provide a car accessory serving as a warning device giving off both sound and light warnings for enhanced safety in dark environments or in unobservable environments for the drivers of the following cars.

A further object of the present invention is to provide an in-car hand-free mobile phone holder which comprises a speaker located close to the head and thus ears of the driver for good quality of communication and ready access to the driver.

Yet a further object of the present invention is to provide a lighting and warning device that comprises magnets for removable attachment to a car body for giving off warnings to the following cars and to allow for repairing carried out in dark environments.

A further object of the present invention is to provide a rechargeable car accessory allowing for charging rechargeable battery by means of the car electricity system and for additionally providing at least the functions of lighting and warning when not charging any rechargeable battery.

A further object of the present invention is to provide a car accessory having the function of cash authentication or counterfeit detection by means of generation of ultraviolet light.

To achieve the above objects, in accordance with the present invention, there is provided a car accessory comprising an elongate bar removably received and retained in a retainer that is selectively attached to a sun visor of a car. The elongate bar forms a connector for connection with a mobile phone and an electrical system of the car. A speaker is mounted to the bar for broadcasting audio signal from the mobile phone and giving off sound signals. A control circuit is arranged in the bar for controlling the operation of the car accessory and synthesizing the sound signals. A battery set is mounted in the bar for powering the car accessory. Three lighting units are mounted to the bar and controlled by switches to selectively give off light signals and serve as a flashlight. The lighting units are operable with the speaker to give off visual and sound signals.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a car accessory and a retainer thereof constructed in accordance with the present invention;

FIG. 2 is an end view of the car accessory of the present invention;

FIG. 3 is a side elevational view of the car accessory of the present invention;

FIG. 4 is a bottom view of the car accessory of the present invention;

FIG. 5 is a side elevational view, partially broken, of the car accessory of the present invention;

FIG. 6 is a top view, partially exploded, of the car accessory of the present invention;

FIG. 7 is an enlarged view, partially broken, of an end portion of the car accessory of the present invention;

FIG. 8 is an exploded end view of the car accessory of the present invention;

FIG. 9A is a top view of the retainer of the present invention;

FIG. 9B is a bottom view of the retainer of the present invention;

FIG. 10 is a side elevational view of the car accessory retained by the retainer in an upright manner; and

FIG. 11 is a schematic view showing the car accessory attached to a sun visor of a car by the retainer.

### DETAILED DESCRIPTION OF THE INVENTION

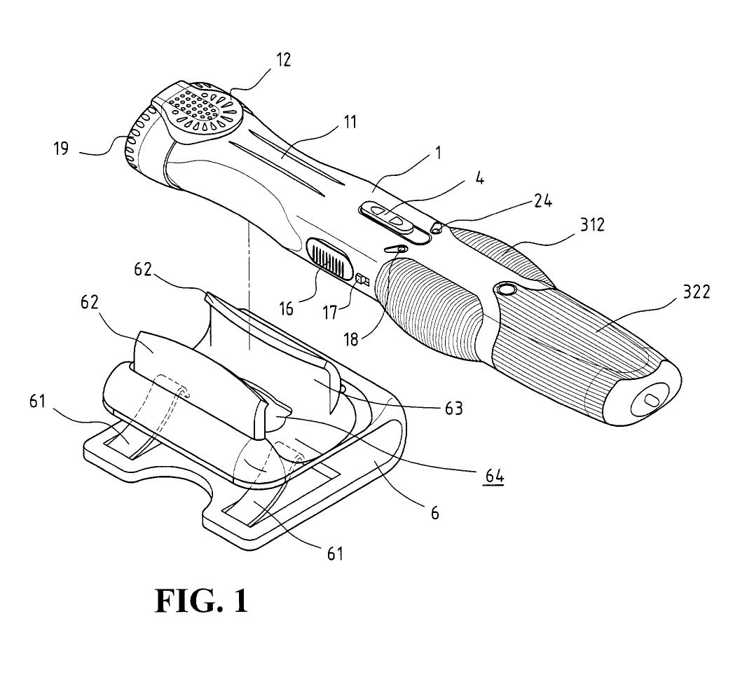

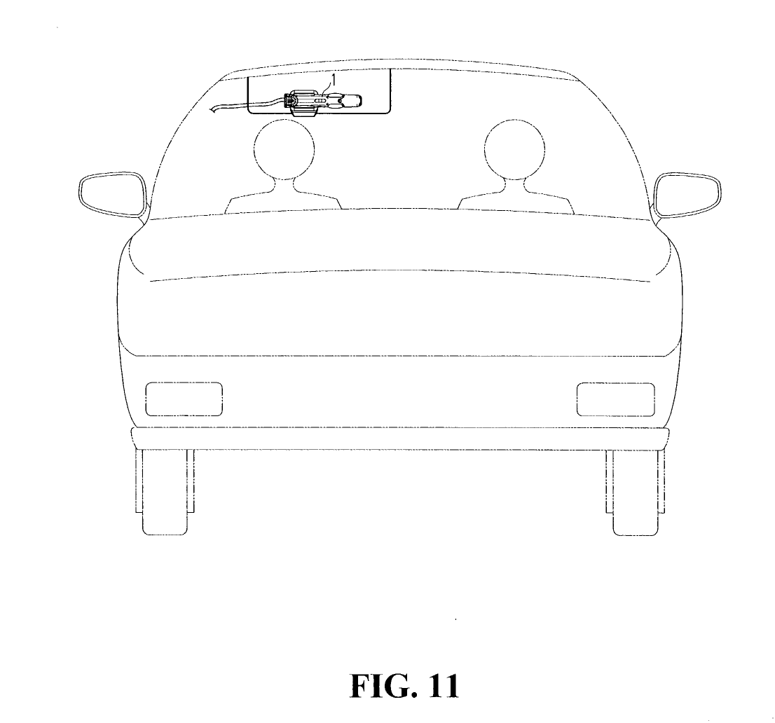

With reference to the drawings and in particular to FIG. 1, a car accessory assembly constructed in accordance with the present invention comprises a car accessory 1 in the form of an elongate bar and a retainer 6 that can be fixed inside a car to retain the car accessory 1. For example and as shown in FIG. 11, the retainer 6 can be releasably attached to a sun visor of a car to retain the car accessory 1 in a desired position inside the car.

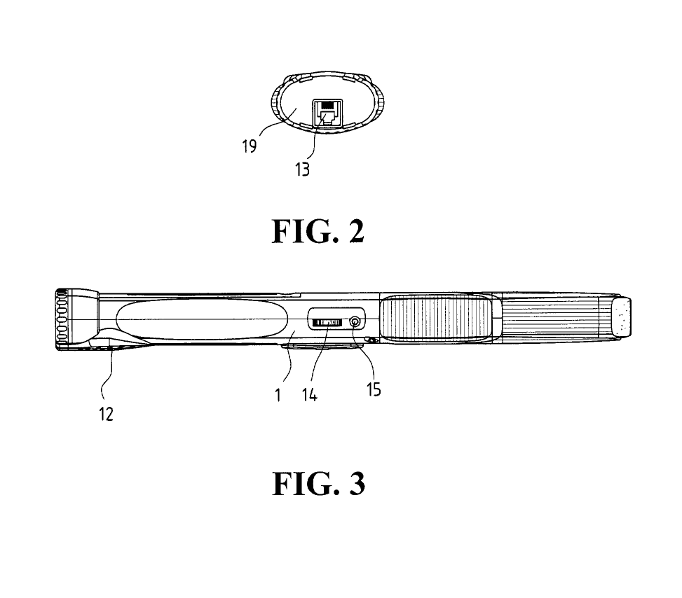

Also referring to FIGS. 2 and 3, the car accessory 1 is made in the form of an elongate bar having a reduced or a necked section 11 formed by opposite recesses (not labeled) defined in opposite left and right side edges of the bar 1 for ready clamp by the retainer 6 and hand holding of a user. A speaker 12 is mounted to a top face of the elongate bar of the car accessory 1 close to a rear end of the bar. A jack or connector 13 is formed on the rear end of the bar 1 for connection with a mobile phone and/or an external electricity system (both not shown). In the embodiment illustrated, the connector 13 comprises four terminals, two for signal transmission and two for power transmission. If desired, the connector 13 may comprise more terminals, such as five or six terminals. A volume control knob 14 is mounted to left side edge of the bar 1 for controlling the volume of the speaker 12. An earphone jack 15 is formed on the left side edge of the bar 1, close to the volume control knob 14, for connection with an earphone plug of a mobile phone (not shown). Circuits and electronics that transmit and process electrical signals for the speaker 12 and the jack 15 (such as synthesizing audio sounds), as well as control and driving of other parts of the car accessory 1, are arranged inside the bar 1.

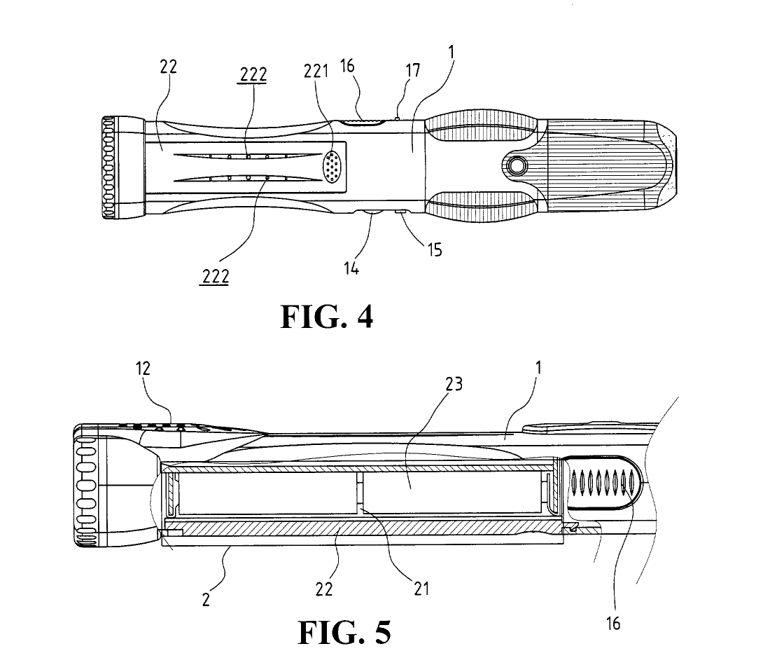

Also referring to FIGS. 4 and 5, a set of batteries 2 is mounted inside the bar 1. A battery compartment 21 is defined in the bar 1 and openably covered by a lid 22. A number of batteries 23 are positioned in the compartment 21 and electrically connect to the circuits of the car accessory 1. In the drawings, only two batteries 23 are visible, more batteries, such as four batteries, can be used although. The batteries 23 are preferably rechargeable batteries and the circuits of the car accessory 1 comprise a charging circuit whereby the car accessory 1 may serve as a battery charger if the car accessory 1 is connected to an external power source, such as a car electricity system. When the car accessory 1 is disconnected from the external power source, the batteries 23 function as an internal power source for the car accessory 1 to drive the speaker 12 and other components. Beads 221 are formed on the lid 22 to enhance manually moving and opening the lid 22. Ventilation holes 222 are defined in the lid 22 for air ventilation and removal of heat generated in for example the charging process. A charging indicator 24 is formed on the top side of the bar 1 for indication of the charging operation. The indicator 24 lights when the batteries 23 are being charged and goes off when the charging is completed.

The car accessory 1 comprises a touch switch 16 which, when touched, triggers a sound generation circuit of the car accessory 1 to give off loud sound through the speaker 12. Preferably, the loud sound is an intermittent whistling sound. The purpose of the generation of the loud sound is to provide (1) security means for driver and/or passengers when they are attacked or when a stranger tries to break into the car or when an accident happens and (2) a safety device when the driver must step off the car to guide the following cars in a car breakdown or traffic accident situation. The loud sound attracts the attention of the following car drivers, reducing the potential risk of additional car collision. The sound goes off when the user removes his or her finger from the touch switch 16.

A main switch 17 is provided close to the touch switch 16. When the main switch 17 is off, the car accessory 1 is completely shut down. Thus, it would be very advisable to shut down the car accessory 1 by means of the main switch 17 when the car accessory 1 is not to use for a long while. An indicator 18, associated with the main switch 17, lights when the main switch 17 is on, and goes off when the main switch 17 is shut down. Preferably, the main switch 17 is a three-stage switch of which the first and second stages correspond to “OFF” and “ON” conditions thereof and the third stage corresponds to a cash authentication or counterfeit currency detection function. When the main switch 17 is at the third stage, a violet light is emitted from the indicator 18 for inspecting a bill. This allows the driver or other user to avoid taking counterfeit currency.

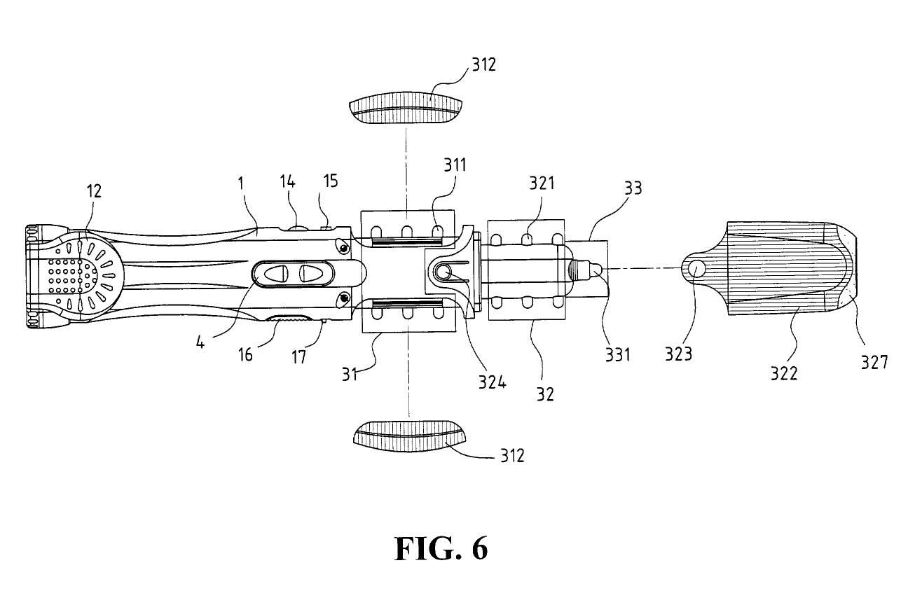

Also referring to FIG. 6, two lighting units 31, 32 are mounted close to the front end of the bar 1. The first lighting unit 31 comprises a number of high brightness light emitting diodes (LEDs) 311 mounted to the left and right side edges of the bar 1 and electrically connect to the batteries 23. Two covers 312 are respectively mounted to the left and right side edges of the bar 1 to shield the LEDs 311. The covers 312 are preferably made of red light transmitting material whereby then the LEDs 311 are energized, the first lighting unit 31 gives off red light from opposite sides of the bar 1. Preferably, the inner surfaces of the covers 312 are processed to enhance the brightness of the first lighting unit 31 and space that can be lighted by the first lighting unit 31.

The second lighting unit 32 comprises a number of high brightness light emitting diodes (LEDs) 321 arranged on the left and right side edges of the bar 1 and located between the front end of the bar 1 and the LEDs 311 of the first lighting unit 31. A conic cover 322 is fit over the front end of the bar 1 and shields the LEDs 321. The cover 32 has opposite extensions located above and below the top and bottom faces of the bar 1. Each extension defines a hole 323 engageable with a resilient projection 324 to secure the cover 32 to the front end of the bar 1. The projection 324 may be made of resilient material or alternatively, the projection 324 is biased by a resilient element, such as a spring (not shown). The cover 322 is preferably made of red light transmitting material whereby then the LEDs 321 are energized, the second lighting unit 32 gives off red light from opposite sides and partially the front end of the bar 1. Preferably, the inner surfaces of the cover 322 is processed to enhance the brightness of the second lighting unit 32 and space that can be lighted by the second lighting unit 32.

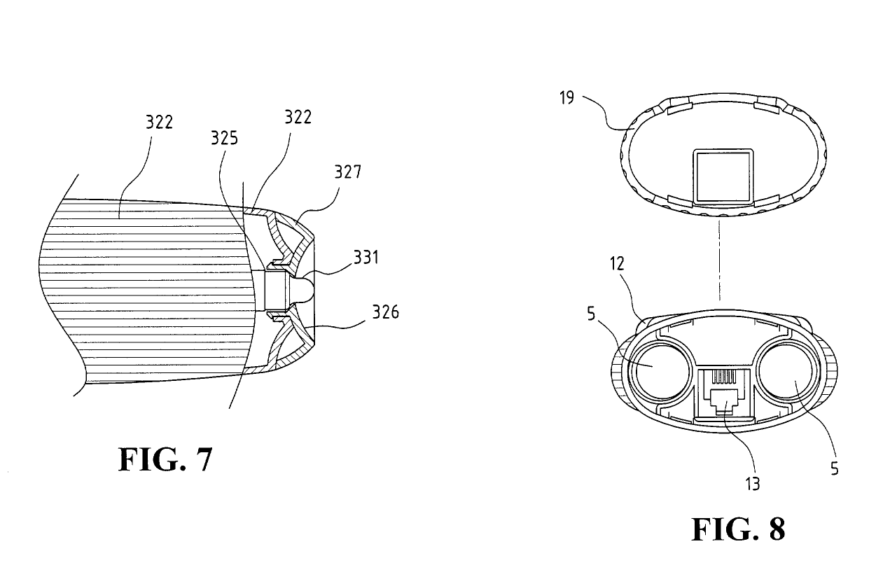

Also referring to FIG. 7, a third lighting unit 33 is mounted to the front end of the bar 1. The third lighting unit 33 comprises a tungsten filament based bulb or other light bulb 331 mounted to the front end of the bar 1. The cover 322 of the second lighting unit 32 that is mounted to the front end of the bar 1 forms a bore 325 for receiving the bulb 331 therein and a concave reflection surface 326 surrounding the bore 325 for reflecting the light of the bulb 331 to the desired direction. The bulb 331 of the third lighting unit 33 allows the car accessory 1 to function as a flashlight or other lighting tool. In the embodiment illustrated, the bore 325 and the reflection surface 326 are formed in a cap 327 that is releasably mounted to the cover 322. This allows for ready coating of a reflection layer that constitutes the reflection surface 326 by means of for example electroplating.

A selection switch 4 is mounted to the top face of the bar 1. The switch 4 is a six-stage switch having first to sixth stages of which the first stage activates the speaker 12 for taking phone call of the mobile phone connected to the car accessory 1 without hand holding the phone. The stage two switches the mobile phone to the earphone jack 15 whereby no hand holding of the mobile phone is required in picking up a phone call. The stage three activates the flash light function by powering the light bulb 331. The stage four activates the warning sign function by powering the first and second lighting units 31, 32 that emit red light for giving off audio warnings. The fifth stage activates an audio warning function by means of the speaker 12, besides the visual warnings of the first and second lighting units 31, 32. The sound can be buzzing or other loud sounds. The sixth stage only turns on the buzzer by means of the speaker 12.

With reference to FIG. 8, the car accessory 1 comprises a rear end cap 19 releasably mounted to the rear end of the bar 1. Two receptacles are defined in the bar 1 on opposite sides of the connector 13 for receiving and retaining magnets 5. Thus, the magnets 5 form a magnetic field that extends beyond the bar 1. The magnets 5 releasably attaches the bar 1 to a ferrous article, such as the car body that is generally made of steel plates. For example, the car accessory 1 can be attached to the top of the car body in electrical failure condition of the car in dark environments for giving warnings or the car accessory 1 can be attached to the side surface of the car body and serves as a lighting device for helping the driver to fix the car in a car breakdown.

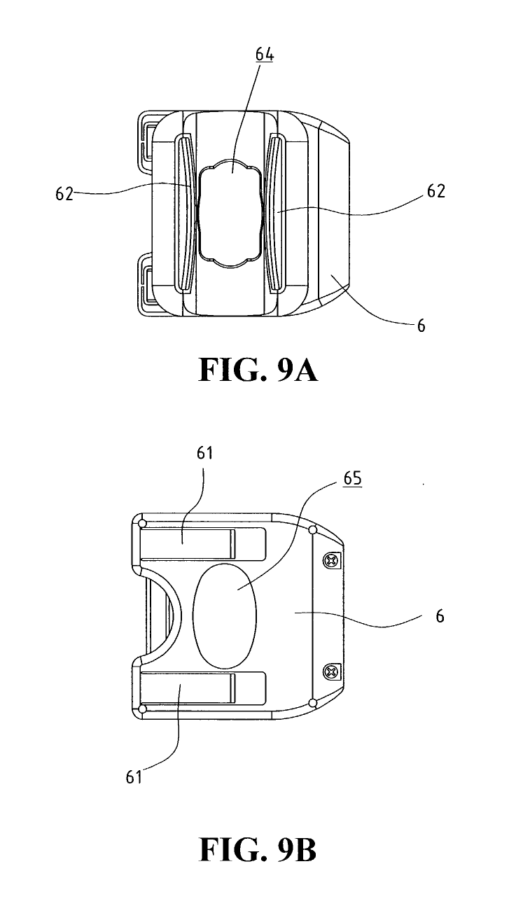

As shown in FIGS. 1, 9A and 9B, the retainer 6 retains the car accessory 1 inside or outside a car, such as attaching the car accessory 1 to a sun visor of the car. The retainer 6 comprises a channel like or lying U-shaped body having resilient upper and lower boards (not labeled), like a clip, for fitting over and thus attaching to the sun visor as shown in FIG. 11. Additional resilient clipping members 61 are formed in the lower board for engaging and thus securely retaining the sun visor to attach the retainer 6 to the sun visor. A clip comprised of two paws 62 is formed on the upper board of the retainer 6. The paws 62 extend from the upper board of the retainer 6 and are opposite to each other with a space 63 defined therebetween. The paws 62 are configured to receive and retain the reduced section 11 of the bar 1 thereby securely mounting the bar 1 to the retainer 6.

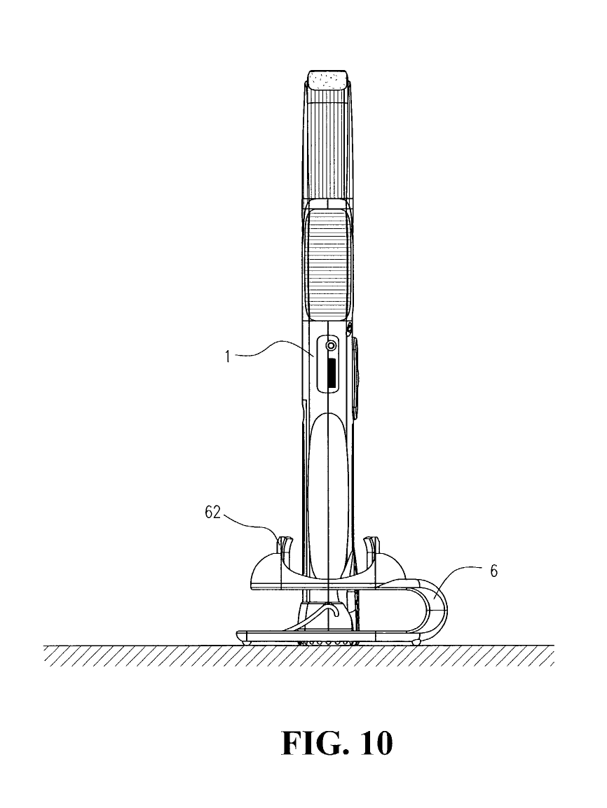

The upper and lower boards of the retainer 6 define aligned bores 64, 65 which are configured to accommodate the rear end of the bar 1 therein for holding the bar 1 in an upright manner as shown in FIG. 10. Preferably, the bore 64 is defined between the paws 62 and the bore 65 is defined between the resilient clipping members 61. The lower board of the retainer 6 functions to provide a large projected surface area for the bar 1 in order to have the bar 1 stably stand on an uneven surface.

When the bar 1 is attached to the sun visor of a car, the speaker 12 is located very close to the head (and thus ears) of the driver. Thus, a good quality of communication through the mobile phone can be obtained. In addition, since the bar 1 is close to the driver, in case that a stranger is attacking or attempting to break into the car, the driver may readily access the touch switch 16 to give off sounds for scaring the stranger and calling for help by attracting other people's attention. In this respect, the car accessory 1 may be provided with a circuit for generation of police whistle sound. In a traffic accident or car breakdown, the car accessory 1 can be mounted to the top of the car for giving warnings in dark environments and can also be used as a lighting tool for fixing the car or for rescuing other people. The audio and video warnings provided by the car accessory also help to warn the drivers of the following cars, especially in dark environments or in an unobservable corner. The car accessory 1 may also serve as a charger for rechargeable batteries. Since the car accessory 1 is almost always connected to the car electrical system for daily operation, it is hardly possible for the flashlight of the car accessory 1 to malfunction due to being long term unused.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A car accessory assembly comprising:
an elongate bar forming a connector for connection with a mobile phone and an external electrical system, a speaker mounted to the bar for broadcasting audio signal from the mobile phone and giving off sound signals;
a control circuit arranged in the bar for controlling the operation of the car accessory and synthesizing the sound signals;
a battery set mounted in the bar for powering the car accessory; and
at least one lighting unit controlled by switching means to give off light signals, the lighting unit being operable with the speaker to give off visual and sound signals.

2. The car accessory assembly as claimed in claim 1, wherein the battery set comprises rechargeable batteries and wherein the control circuit comprises a charging circuit for charging the rechargeable batteries.

3. The car accessory assembly as claimed in claim 1, wherein the bar defines a compartment inside which the battery set is positioned, a lid openably covering the compartment, the lid forming a plurality ventilation holes.

4. The car accessory assembly as claimed in claim 1, wherein the switching means comprises a selection switch movable to a stage to activate the speaker to give off buzzing sound.

5. The car accessory assembly as claimed in claim 1, wherein the switching means comprises a touch switch, which activates the speaker to give off intermittent whistling sound.

6. The car accessory assembly as claimed in claim 1, wherein the lighting unit comprises a number of light emitting diodes arranged on opposite sides of the bar and are selectively shielded by covers.

7. The car accessory assembly as claimed in claim 1, further comprising a flash light unit comprising a bulb mounted to an end of the bar and surrounded by a concave reflection surface.

8. The car accessory assembly as claimed in claim 1, further comprising magnets mounted inside the bar for attaching the bar to a ferrous article.

9. The car accessory assembly as claimed in claim 1, further comprising a retainer for receiving and retaining the bar.

10. The car accessory assembly as claimed in claim 9, wherein the retainer comprises a channel-like body having upper and lower boards, resilient clipping members being mounted to the lower board, paws being formed on the upper board and defining a space therebetween for accommodating the bar therein.

11. The car accessory assembly as claimed in claim 10, wherein the upper and lower boards of the retainer define aligned bores for accommodation of an end of the bar.

12. A retainer comprising a lying U-shaped body having upper and lower boards, the upper and lower boards defining aligned bores for accommodating an end of an elongate article for holding the article in an upright manner, the bores being configured to comply with outer shape of the article.

13. The retainer as claimed in claim 12, further comprising resilient clipping members formed on the lower board and two paws formed on the upper board and defining a space therebetween for retaining the elongate article.

14. The retainer as claimed in claim 13, wherein the bore of the upper board is defined between the paws and the bore of the lower board is defined between the resilient clipping members.
